(19) United States
(12) Patent Application Publication
(10) Pub. No.: US 2026/0298276 A1
(43) Pub. Date: Oct. 1, 2026

(54) CLOSURE FOR CONNECTING WORKPIECES

(71) Applicants: ANEMO ENGINEERING BV, Diksmuide (BE); EYESTONE BV, Alveringem (BE)

(72) Inventor: Bart VANDEZANDE, Alveringem (BE)

(21) Appl. No.: 19/479,545

(22) PCT Filed: Apr. 30, 2024
(86) PCT No.: PCT/IB2024/054178

§ 371 Date: Oct. 28, 2025

(30) Foreign Application Priority Data
Apr. 30, 2023 (BE) 2023/5352

(51) Int. Cl. F16B 21/02; F16B 5/06

(52) U.S. Cl. CPC F16B 21/02; F16B 5/0642

(57) ABSTRACT

A system and method for connecting two or more workpieces is provided. The closure is designed in this respect to attach the workpieces together by manipulation of the closure from one side of the workpieces, while the use of the closure in the workpieces requires only openings to be provided and thus does not require any other machining of the workpieces themselves. The closure is also designed to induce a force perpendicular to the workpieces by rotation when the closure is secured to the workpieces so as to hold the workpieces together.

### FIELD OF APPLICATION OF THE INVENTION

The present invention relates generally to systems and methods for connecting two or more workpieces. More specifically, the present invention comprises a closure for connecting two or more workpieces, as well as a method utilising such a closure for connecting two or more workpieces.

### BACKGROUND OF THE INVENTION

Quarter turn closures are a widespread category of structural elements that allow two or more workpieces to be attached together. The disadvantage of quarter turn closures on the market today is that, when they are used, one or more of the following problems are often encountered. Often, both sides of the workpieces must be accessible in order to fit the quarter turn closure. In some cases, the quarter turn closure provides only one or several of a high clamping tension, a high tensile tension or a high shear tension. In many cases, difficult operations need to be performed on the workpieces, such as threading or otherwise connecting parts of the quarter-turn closure.

There is therefore scope for a closure that solves one or more of the above problems.

### SUMMARY OF THE INVENTION

It is an object of embodiments according to the present invention to provide systems and methods for connecting two or more workpieces.

This object is achieved by systems and methods according to the present invention.

In a first aspect, the present invention relates to a closure for connecting at least two workpieces to be attached together, characterised in that the closure is designed to attach the workpieces together by manipulation of the closure from one side of the workpieces, while the use of the closure in the workpieces requires only one or more openings to be provided—and thus does not require any other machining of the workpieces themselves—and in that the closure is designed to induce a force perpendicular to the workpieces by rotation when the closure is secured to the workpieces so as to hold the workpieces together.

The closure may, for example, be a quarter turn closure, wherein, by rotating the components relative to each other through an angle of substantially 90°, the closure can change between an open and a closed state. embodiments of the present invention also closures, wherein the change between an open and closed state is induced by rotation of a part of the closure through a different angle, such as, for example, over—but not limited to—120°.

It is an advantage of embodiments of the present invention that the closure can be operated as one single element, making fitting simpler.

It is an advantage of embodiments of the present invention that the closure can be handled from one side such that the rear side of the pieces to be connected together does not need to be accessible from that side for assembly. In other words, the closure according to embodiments of the present invention can be provided such that there is no need for a second part (counter-part) to be fitted on the other side of the workpieces which are to be connected together, in which case the first part would interact with the second part.

It is an advantage of embodiments of the present invention that the closure provides both high shear resistance and high clamping force as well as tensile force. In this way, the workpieces together form a robust structure. In such a structure, the workpieces are resistant to being easily sheared relative to each other and to being easily detached from each other.

Due to the limited number of components, the risk of losing components of the closure is more limited or can even be avoided.

The closure can comprise a first part, a second part and rolling elements, wherein the first part, the second part and the rolling elements are designed and positioned such that by relative rotation of the first part and the second part in a reference plane, the rolling elements move about an inclined plane, causing the first part and the second part to make a movement relative to each other in the direction perpendicular to the reference plane.

It is an advantage of embodiments of the present invention that the closure provides a sufficiently large clamping force such that the pieces to be connected to each other do not detach from each other, i.e. such that there is no clearance between the workpieces and the workpieces cannot slide relative to each other.

It is an advantage of embodiments of the present invention that the closure is resistant to a high tensile force. In other words, when the closure is installed to connect two pieces to each other, a high tensile force can be applied to both components before the components detach.

It is an advantage of embodiments of the present invention that the closure has good resistance to shear forces, i.e. that two pieces attached together by means of a closure according to an embodiment of the present invention do not slide or slide little relative to each other.

It is an advantage of embodiments of the present invention that the closure enables a combination of a large clamping force, resistance to a large tensile force and resistance of the connected workpieces to shear forces.

The rolling elements can, during relative rotation of the first part and the second part to the closing position, fall into a notch on the inclined plane, generating a click in the closure when the closure has reached its closing position.

It is an advantage of embodiments of the present invention that it is clearly perceptible to the user when the closure is fitted in its closed position. It is further an advantage of embodiments of the present invention that the closure cannot simply detach by itself, for example in case of vibration or the like.

The closure can comprise a spring-loaded element between the first part and the second part of the closure for inducing a clamping force on the workpieces.

The spring-loaded element may be a dish spring or a leaf spring. In some embodiments, the spring-loaded element may also be a spring ring, a wavy spring ring, a coil spring, . . . or an element with a similar function.

The rolling elements may be balls.

The closure may be 50%, for example 75%, made of a plastic.

The closure may be provided with an ergonomic knob to induce rotation of the closure between its open and closed state.

In some embodiments, such an ergonomic knob may be omitted and replaced by a closure element that can be operated using tools, for example specific tools that do not allow simply anyone to open or close the closure. This may constitute an additional form of security, if required for some structures.

In some embodiments, the closure will be provided with a closing element on one side, such that the first part and the second part can rotate relative to each other by manipulating the closing element with a specific tool.

It is an advantage of the closure that it can be applied without drawing wire on elements or providing chamfers, thus eliminating the need for post-processing on workpieces.

The closure can be designed to attach together workpieces with a total thickness between 1 mm and 300 mm. For this purpose, additional spacer elements can be used in the closure, for example. Depending on the total thickness of the workpieces, one or more spacer elements can be used in this case. By using such spacer elements, it can be ensured that the clamping tension provided by the closure is always within a desired range.

The closure may be provided with one or more sealing means.

In a further aspect, the present invention also relates to a structure comprising a closure as described above and two workpieces attached together by means of the closure.

The two workpieces can be provided with openings, wherein in at least one of the workpieces the opening is not rotationally symmetrical and has a shape through which at least part of the closure fits, and wherein after rotation, this part of the closure may clamp onto the workpiece.

In another aspect, the present invention also relates to the use of a closure for connecting two or more workpieces.

Specific and preferred aspects of the invention are included in the appended independent and dependent claims. Features of the dependent claims may be combined with features of the independent claims and with features of other dependent claims as appropriate and not merely as expressly set out in the claims.

### BRIEF DESCRIPTION OF THE FIGURES

FIG. 1 shows a cross-sectional view of a quarter turn closure at the level of the rotating elements for a quarter turn closure in an open state, in accordance with an embodiment of the present invention.

FIG. 2 shows another cross-sectional view of a quarter turn closure for a quarter turn closure in a closed state, in accordance with an embodiment of the present invention.

FIG. 3 shows a representation of the components of a quarter turn closure spaced apart in accordance with an exemplary embodiment of the present invention.

FIG. 4 shows a representation of the components of a quarter-turn closure and the workpieces to be attached together, spaced apart in accordance with an exemplary embodiment of the present invention.

### DETAILED DESCRIPTION OF ILLUSTRATIVE EMBODIMENTS

The present invention will be described with reference to specific embodiments but the invention is not limited thereto and is limited only by the claims.

It should be noted that the term “includes” and “comprises”, as used in the claims, is not to be construed as limited to the means described thereafter; this term does not exclude other elements or steps. It can therefore be interpreted as specifying the presence of the stated features, values, steps or components referred to, but does not exclude the presence or addition of one or more other features, values, steps or components, or groups thereof. Thus, the scope of the expression “a device including means A and B” should not be limited to devices consisting only of components A and B. It means that with regard to the present invention, A and B are the only relevant components of the device.

Reference throughout this specification to “one embodiment” or “an embodiment” means that a specific feature, structure or characteristic described in connection with the embodiment is included in at least one embodiment of the present invention. Thus, occurrences of the phrases “in one embodiment” or “in an embodiment” at various places throughout this specification do not necessarily all refer to the same embodiment, but may do so. Furthermore, the specific features, structures or characteristics may be combined in any suitable manner, as would be apparent to one of ordinary skill in the art, based on this disclosure, in one or more embodiments.

Similarly, it should be appreciated that in the description of exemplary embodiments of the invention, various features of the invention are sometimes grouped together into a single embodiment, figure or description thereof for the purpose of streamlining disclosure and aiding in the understanding of one or more of the various inventive aspects. In any case, this method of disclosure should not be interpreted as reflecting an intention that the invention requires more features than those explicitly stated in each claim. Rather, as the following claims reflect, inventive aspects lie in less than all the features of a single previously disclosed embodiment. Thus, the claims following the detailed description are hereby expressly incorporated into this detailed description, with each claim standing alone as a separate embodiment of this invention.

Furthermore, while some embodiments described herein include some, but not other, features included in other embodiments, combinations of features of different embodiments are intended to be within the scope of the invention, and constitute different embodiments, as would be understood by those skilled in the art. For example, in the following claims, any of the described embodiments may be used in any combination.

It should be noted that the use of certain terminology in describing certain features or aspects of the invention should not be construed as implying that the terminology herein is redefined so as to be limited to specific features of the characteristics or aspects of the invention with which this terminology is linked.

Although reference is often made in the description to a quarter turn closure in which the change between an open and closed state of the closure is typically induced by a rotation of a part of the closure through 90°, embodiments of the present invention also relate to closures in which the change between an open and closed state is induced by rotation of a part of the closure through a different angle, such as, for example, over—but not limited to—120°.

In a first aspect, the present invention relates to a closure for connecting at least two workpieces to be attached together. Thus two workpieces are typically components of a structure. The typical structures in which the closure can be used are not limited, but the closure can have particular additional benefits in applications requiring high shear resistance as well as a high clamping force and tensile force. Moreover, the closure can also offer particular additional benefits in structures where access to both sides of the workpieces to be connected together is limited. The closure of the present invention is one that is designed to attach the workpieces together by manipulation of the closure from one side of the workpieces, and is designed to induce a force perpendicular to the workpieces by rotation when the closure is secured to the workpieces so as to hold the workpieces together.

In advantageous embodiments, the closure comprises a first part, a second part and rolling elements which are designed and positioned such that by relative rotation of the first part and the second part in a reference plane, the rolling elements move about an inclined plane, causing the first part and the second part to make a relative movement with respect to each other in the direction perpendicular to the reference plane. Both the first part and the second part may themselves further consist of separate components attached together or partly separate and partly attached components. In some embodiments, the inclined plane may be obtained by providing a groove of variable depth in the first or second part, in which the rolling elements move by rotating the first and second parts relative to each other and by means of which the rolling elements push the first and second parts apart to a lesser or greater extent, thus causing a relative displacement of the first part and the second part perpendicular to the direction of rotation. This allows the workpieces to be clamped together.

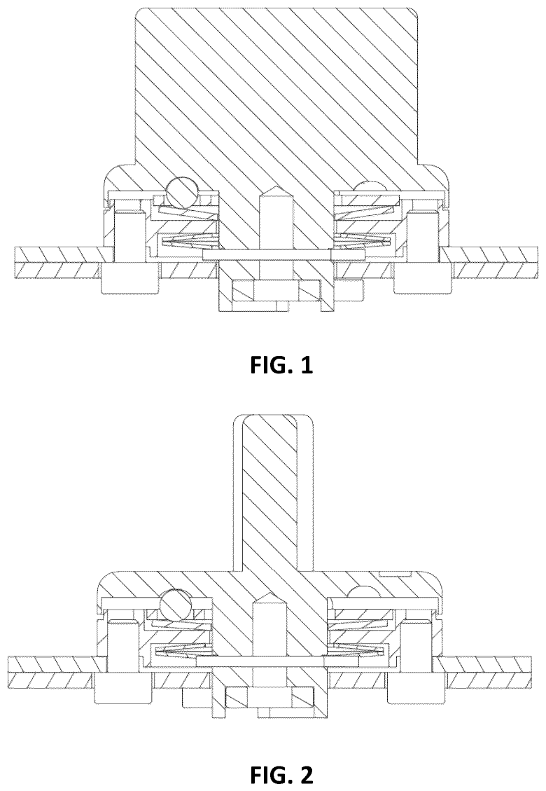

By way of illustration—embodiments of the present invention not being limited thereby—an example of a possible embodiment of a closure, in this case a quarter turn closure, is shown in FIG. 1 and FIG. 2. These figures show the closure in an open and a closed state.

In closures according to the present invention, at least one piece of a part of the closure has a non-rotationally symmetrical shape, such that, after being inserted through a non-rotationally symmetrical opening in at least one of the workpieces, it can clamp behind this workpiece after rotation.

In some embodiments, the rolling elements may be balls.

In some embodiments, the closure may be provided such that a click is generated when the closure has reached its closing position. This promotes ease of use, as it signals to the user that the closure is in the closed state. One possible way to achieve this is by having the rolling elements fall into a notch during relative rotation of the first part and the second part.

In some embodiments, the closure comprises a spring-loaded element between the first part and the second part of the closure for inducing a clamping force on the workpieces. Such a spring-loaded element may be, for example, a leaf spring, although other spring-loaded elements such as a wave ring, a wire spring or a dish spring may also be used.

In some embodiments, the closure may have a sealing effect on one or more sides of the workpieces. One or more sealing means can be used for this purpose. These sealing means may be sealing rings. The sealing means can, for example, be made of EPDM, FKM, silicone, Buna-N, etc.

In some embodiments, the closure also comprises a spacer ring element that allows the closure to be adapted to connect workpieces with different overall thicknesses. Depending on the spacer element, workpieces with different overall thicknesses can in this case still be efficiently attached together. It is thus possible to attach together workpieces with a total thickness between 1 mm and 300 mm.

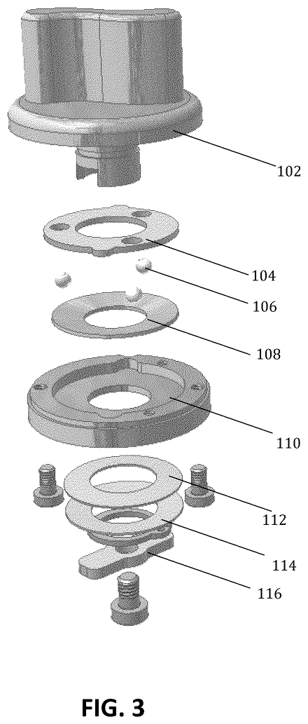

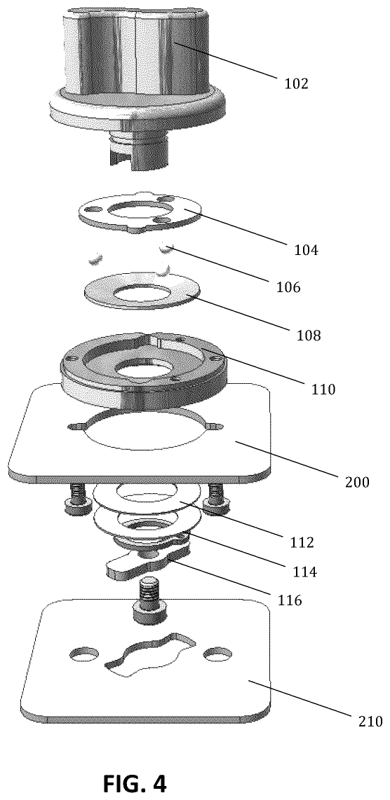

An example of the different components in a sample quarter turn closure is further shown in FIG. 3 and FIG. 4, wherein FIG. 3 shows the different parts of the quarter turn closure itself, while FIG. 4 shows those same parts in addition to the workpieces to be connected together. The different components that can be seen on the closure 100 are: a handle (which may or may not be ergonomic) 102—in the present embodiment, this handle also comprises the inclined plane on which the rolling elements will move—, a positioning element 104 for the rolling elements 106, the rolling elements 106 themselves, a dish spring 108, and positioning element 110, further dish springs 112, 114 and a non-rotationally symmetrical component 116. The workpieces 200 and 210 are also visible in FIG. 4. Further elements for attaching components of the closure together or additional positioning elements may also be present.

In some embodiments, the closure may be a closure according to the first part of the claim and having optional features as provided in any one of the other embodiments described herein, but wherein the closure is for the most part, i.e. at least 50%, for example at least 75% or for example at least 90%, produced from a material lighter than steel, such as for example aluminium, titanium, ABS, glass fibre-reinforced plastics, acetal, nylon or plastic. It is an advantage of some embodiments that they result in a well-functioning quarter turn closure while having a low weight, which can offer advantages in various applications such as, for example, in the transport sector.

In some embodiments, some or all components of the closure may be formed from stainless materials such as, for example, stainless steel, stainless steel 316, polyprop, peek, polycarbonate, polyethylene, polysulfone.

In some embodiments, some or all components of the closure may be formed from special materials capable of resisting high temperatures, such as Inconel or Monel.

In some embodiments, some or all components of the closure may be formed from materials that are readily treatable, such as cast zinc or chrome-plated brass.

In some embodiments, the closure may be a closure according to the first claim and having optional features as provided in any one of the other embodiments described herein, but wherein the closure is further provided with an ergonomic handle. An example of such an ergonomic handle is provided in FIG. 3 and FIG. 4. Such an ergonomic handle may provide greater ease of use for the user. It may be shaped such that the user has a good grip on the handle and therefore can easily turn the handle. In some embodiments, the handle may also simply be a rotary knob, provided as a protrusion without any further ergonomic aspects being provided on the protrusion. In yet other embodiments, the closure may also be provided without a specific rotary knob, in which case only a locking plate or another locking structural element is provided on that side of the closure, for example an element that can be manipulated with a specific tool such that the first and the second part rotate relative to each other and the closure can thus switch between an open and closed state. This has the advantage that it is not possible for anyone to simply open or close the closure.

In a second aspect, the present invention also relates to a structure comprising a closure in accordance with the first aspect and two workpieces attached together by means of the closure. The two workpieces are in this case provided with openings, wherein in one of the workpieces the opening is not rotationally symmetrical and has a shape through which at least part of the closure fits. In this way, the closure can be fitted from one side of the structure. After rotation, this part of the closure can then clamp onto the workpiece.

In yet another aspect, the present invention relates to the use of a closure according to any one of the preceding claims for connecting two or more workpieces.

1.-13. (canceled)

14. A closure for connecting at least two workpieces to be attached together, wherein
the closure is designed to attach the workpieces together by manipulation of the closure from one side of the workpieces, while the use of the closure in the workpieces requires only one or more openings to be provided, and in that
the closure is designed to induce a force perpendicular to the workpieces by rotation when the closure is secured to the workpieces so as to hold the workpieces together,
wherein the closure comprises a first part, a second part and rolling elements, and
wherein the first part, the second part and the rolling element are designed and positioned such that by relative rotation of the first part and the second part in a reference plane, the rolling elements move about an inclined plane, causing the first part and the second part to make a movement relative to each other in the direction perpendicular to the reference plane.

15. The closure according to claim 14, wherein the rolling elements, during relative rotation of the first part and the second part to the closing position, fall into a notch on the inclined plane, generating a click in the closure when the closure has reached its closing position.

16. The closure according to claim 14, wherein the closure comprises a spring-loaded element between the first part and the second part of the closure for inducing a clamping force on the workpieces.

17. The closure according to claim 16, wherein the spring-loaded element is a dish spring.

18. The closure according to claim 16, wherein the rolling elements are balls.

19. The closure according to claim 14, wherein the closure is 50%, for example 75%, made of a plastic.

20. The closure according to claim 14, wherein the closure is provided with an ergonomic knob to induce rotation of the closure such that the closure can alternate between its open and closed state.

21. The closure according to claim 14, wherein the closure is provided with a closing element on one side, such that the first part and the second part can rotate relative to each other by manipulating the closing element with a specific tool.

22. The closure according to claim 14, wherein the closure is designed to attach together workpieces having a total thickness between 1 mm and 300 mm.

23. The closure according to claim 14, wherein the closure is provided with one or more sealing means.

24. A structure comprising a closure according to claim 14 and two workpieces attached together by means of the closure.

25. The structure according to claim 13, wherein the two workpieces are provided with openings,
wherein in one of the workpieces the opening is not rotationally symmetrical and has a shape through which at least part of the closure fits.

26. A use of a closure according to claim 13 for connecting two or more workpieces.
